(19) United States
(12) Patent Application Publication
(10) Pub. No.: US 2003/0190089 A1
(43) Pub. Date: Oct. 9, 2003

(54) APPARATUS AND METHOD FOR SYNTHESIZING IMAGES

(76) Inventors: TAKEO KATSUDA, SAGAMIHARA-SHI (JP); YUTAKA TOURAI, TOYOHASHI-SHI (JP)

Correspondence Address: SIDLEY AUSTIN BROWN & WOOD LLP, 717 NORTH HARWOOD, SUITE 3400, DALLAS, TX, 75201, US

(21) Appl. No.: 09/452,574

(22) Filed: Dec. 1, 1999

(30) Foreign Application Priority Data
Dec. 2, 1998 (JP) 10-342803

(51) Int. Cl. G06K 9/36

(52) U.S. Cl. 382/284

(57) ABSTRACT

An apparatus synthesizes a first image and a second image to obtain a synthesized image. The apparatus has a storage device and a processor. The storage device stores image data and attribute data for the image data such as data concerning a main light source and an auxiliary light source for the synthesized image, an anteroposterior positional relationship between the first and second images in the synthesized image, etc. The processor image-processes the first and second images on the basis of the attribute data to synthesize these images.

This application is based on application No. 10-342803 filed in Japan, the entire content of which is hereby incorporated by reference.

### BACKGROUND OF THE INVENTION

1. Field of the Invention

The present invention generally relates to an image synthesizing apparatus and method for synthesizing a plurality of images and, more particularly, to an image synthesizing apparatus for synthesizing first and second image data each representing an image to output synthesized image data.

2. Description of the Related Art

Automatic seal printers which synthesize an input image obtained by photographing an object and a background image prepared in advance and then output a synthesized image are on the market these days.

In such automatic seal printers, however, for image synthesis the input image is merely laid on the background image. Therefore, the obtained synthesized image may be unnatural. For example, if a background image at sunset is selected, the background in the synthesized image is reddish, whereas an object, e.g., a person, has daylight colors (colors under light source of an automatic seal printer). In addition, when scenery photographed against the light is selected as a background image, a resulting synthesized image is also unnatural because the object is not photographed against the light. Thus, the synthesized image gives a viewer a feeling that there is something incongruous in the synthesized image because the object and the background are not matching in illumination conditions.

### SUMMARY OF THE INVENTION

It is an object of the present invention to provide an image synthesizing method and apparatus capable of generating a synthesized image that seem to be very natural and does not give a viewer a feeling that there is something incongruous in the synthesized image.

In order to accomplish the above object, according to an aspect of the present invention, there is provided a method for synthesizing a first image and a second image to obtain a synthesized image, comprising the steps of:

setting data concerning a main light source for the synthesized image; and

image-processing the first and second images on the basis of the data concerning the main light source to thereby synthesize these images.

This method can be carried out by, for example, an apparatus according to another aspect of the present invention, which synthesizes a first image and a second image to obtain a synthesized image, and which comprises:

a storage device which stores attribute data representing image synthesis conditions, the attribute data including data concerning a main light source for the synthesized image; and

a processor for image-processing the first and second images on the basis of the attribute data to thereby synthesize these images.

The first and second images may be image-processed such that illumination conditions for the synthesized image meet the data concerning the main light source.

The data concerning the main light source may be a position, luminance, and/or color of the main light source in the synthesized image.

In one embodiment, the position, luminance, and color of the main light source are set in this order.

The attribute data may further include data concerning an auxiliary light source for the synthesized image, and the processor image-processes the first and second images such that illumination conditions for the synthesized image meet both the data concerning the main light source and the data concerning the auxiliary light source.

Further, the attribute data may further include data indicative of a depth-direction anteroposterior positional relationship between the first and second images in the synthesized image, and the processor image-processes the first and second images such that illumination conditions for the synthesized image meet both the data concerning the main light source and the data indicative of the depth-direction anteroposterior positional relationship.

A user may be allowed to manually set the attribute data such as the data concerning the main light source, the data concerning the auxiliary light source, and the data indicating the depth-direction anteroposterior positional relationship between the first and second images.

Other objects and features of the present invention will be obvious from the following description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic block diagram of an image synthesizing apparatus of an embodiment of the present invention;

FIG. 2 shows an operation flow of the image synthesizing apparatus of FIG. 1;

FIGS. 3A, 3B, 3C, 3D and 3E show a flow of image data in generating a synthesized image by the image synthesizing apparatus;

FIG. 4 shows a flow of an image synthesis processing to be executed by the image synthesizing apparatus;

FIGS. 5A, 5B, and 5C show images to be synthesized, respectively;

FIG. 5D shows a manner in which the images shown in FIGS. 5A-5C are placed on one another;

FIGS. 6A, 6B, and 6C illustrate how to move or displace an image on a display screen of the image synthesizing apparatus;

FIG. 7 shows a whole display screen of the image synthesizing apparatus;

FIG. 8 shows items of attribute data stored in a storage device of the synthesizing apparatus;

FIG. 9 shows the size of an image to be synthesized;

FIGS. 10A, 10B, and 10C show contents of attribute data, stored in the storage device, for each of images to be synthesized;

FIG. 11 shows locations of a main light source and an auxiliary light source;

FIG. 12 shows a manner in which images to be synthesized are laid one on another;

FIGS. 13A and 13B show images to be synthesized and a resulting synthesized image, respectively;

FIG. 14A shows images which are synthesized without using the auxiliary light source; and

FIGS. 14B and 14C show images which are synthesized using the auxiliary light source, and the resulting synthesized image, respectively.

### DETAILED DESCRIPTION OF THE PREFERRED EMBODIMENTS

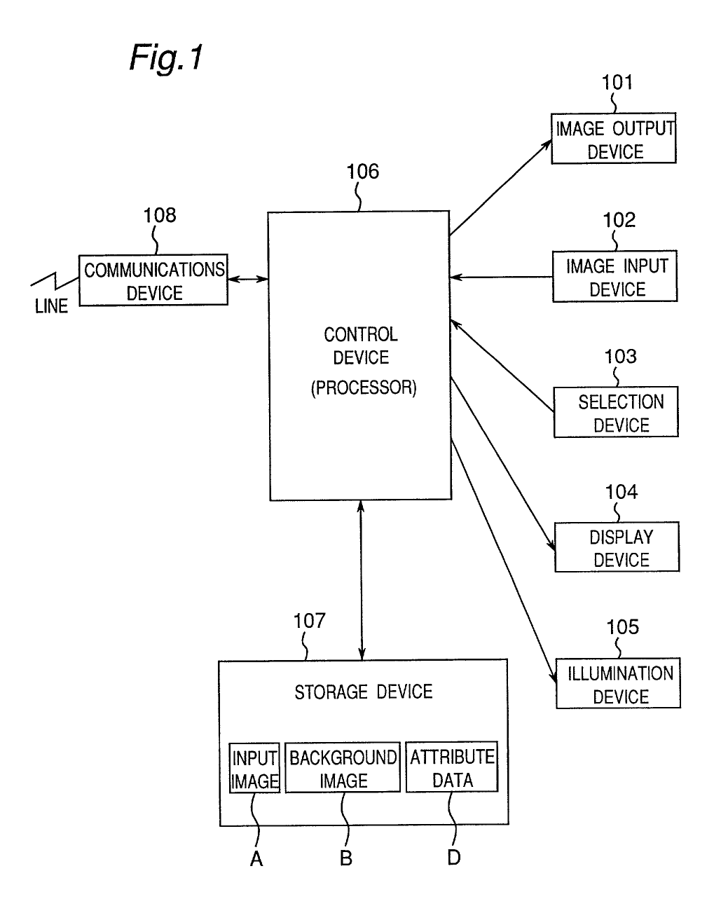

FIG. 1 is a schematic block diagram showing an image synthesizing apparatus of an embodiment of the present invention. The image synthesizing apparatus has a control device 106 for controlling the operation of the entire image synthesizing apparatus. The control device 106 is constructed of a personal computer and has a CPU (central processing unit) and an image-processing IC (integrated circuit). The control device 106 is connected with an image output device 101, an image input device 102, a selection device 103, a display device 104, an illumination device 105, a storage device 107 operating as an image storing device and an attribute storing device, and a communications device 108.

The image output device 101 may be, for example, a video printer, a heat transfer printer, an FD (floppy disk) drive, and/or a PC card drive. The image output device 101 produces a printed output of a synthesized image or outputs data of the synthesized image.

The image input device 102 may be, for example, a video camera, a FD (floppy disk) drive, and/or a PC card drive. From the outside of the image synthesizing apparatus, the image input device 102 takes in image data indicating images to be synthesized.

The selection device 103 may be, for example, a press button switch, a lever switch, a touch panel, a keyboard, and/or a mouse. A user uses the selection device 103 to give an instruction to the image synthesizing apparatus or make a selection.

The display device 104 may be, for example, an LCD (liquid crystal display) or a CRT (cathode-ray tube) and displays an image sent from the control device 106 on a display screen. Viewing an image displayed on the display screen, the user knows that the user is being requested to give an instruction or make a selection for an operation of the image synthesizing apparatus.

The illumination device 105 may be, for example, a fluorescent lamp, a lamp of other type, or an LED for illuminating an object.

The storage device 107 includes a memory such as a RAM (random access memory). The storage device 107 also includes a HD (hard disk) device. In this embodiment, the storage device 107 stores input images as first image data A. The input images indicate respective objects (which can be the user himself or herself) photographed by the video camera serving as the image input device 102. In addition, the storage device 107 stores background images as second image data B. The background images are input through the FD drive or the PC card drive serving as the image input device 102. One image or picture consists of an aggregate of pixels (image bits) having data of 256 gradations for each of primary colors R (red), G (green), and B (blue). In this embodiment, each of an input image and a background image which correspond to one picture is rectangular and has a size of 100 bits long×150 bits wide (see FIG. 9). Attribute data D indicating synthesizing conditions of the input image and the background image are set by the control device 106 and stored in the corresponding area of the storage device, as shown in FIG. 1, during the image synthesis processing which will be described later.

Through public lines, radio, and the like, the communications device 108 communicates with a host computer and a terminal provided outside the image synthesizing apparatus about image data, and sequence software and recorded contents of the control device 106.

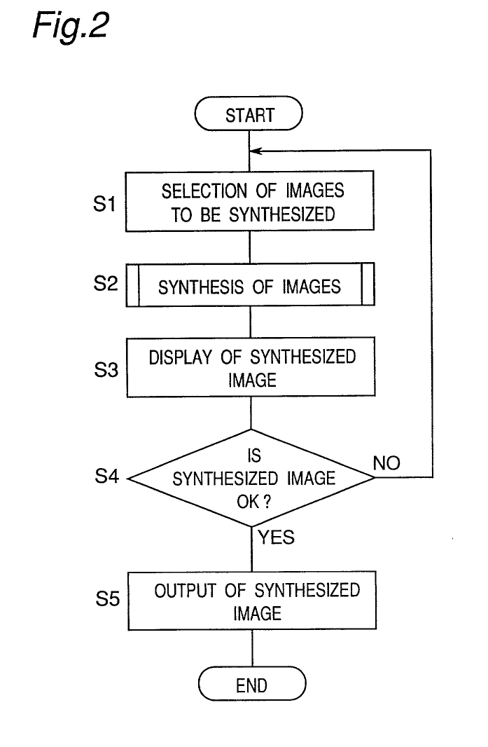

The image synthesizing apparatus operates basically following an operation flow shown in FIG. 2. The start of the operation of the image synthesizing apparatus is instructed by the user turning on a switch or inserting a coin. The following describes the operation of the image synthesizing apparatus with reference to FIG. 2.

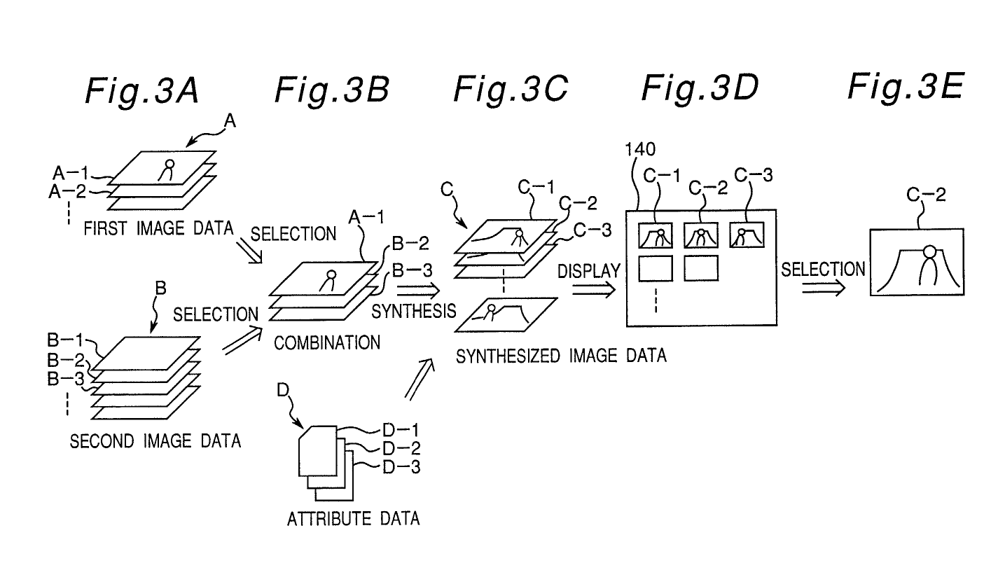

1. Initially, at step S1, the user selects a plurality of images to be synthesized. It is assumed here that one input image A-1 is selected from among a plurality of input images A-1, A-2, . . . indicating objects and that two background images B-2, B-3 are selected from among a plurality of background images B-1, B-2, B-3 . . . , as shown in FIGS. 3A through 3B.

The input images A-1, A-2, . . . are of the objects photographed by the video camera and then stored in the storage device 107. On the other hand, the background images B-1, B-2, B-3, . . . are images stored in advance in the storage device 107 for the user's convenience by, for example, an installer of the image synthesizing apparatus. Because the user is allowed to select images to be synthesized from among a plurality of the images A-1, A-2, . . . and B-1, B-2, B-3, . . . , the user can obtain a synthesized image according to the user's preference. Further, the number of images to be synthesized is not limited to two, but the user can select three or more images to be synthesized. Thus, various synthesized images can be generated.

2. Then, at step S2, the control device 106 operates as a processor to synthesize images. As shown in FIGS. 3B to 3C, based on the user's selection and the attribute data D stored in the storage device, the control device 106 synthesizes the input image A-1 and the background images B-2 and B-3 to generate data of a synthesized image C. In the example shown in FIGS. 3A-3E, a plurality of synthesized images C-1, C-2, C-3, . . . are obtained from the combinations of the input image A-1 and the background images B-2, B-3. The image synthesis processing to be executed at step S2 will be described in detail later.

3. Then, at step S3, the synthesized images C-1, C-2, C-3, . . . are displayed in an arrayed manner on a display screen 140 of the display device 104, as shown in FIG. 3D to ask the user about whether the user likes any one of the synthesized images C-1, C-2, C-3, . . . at step S4. The user can easily select a synthesized image which the user likes by comparing the displayed synthesized images C-1, C-2, C-3, . . . with each other, because they are arranged side by side on the display screen 140.

4. At step S5, as shown in FIGS. 3D-3E, if the user once selects, through the selection device 103, a desired synthesized image, a synthesized image C-2 in this example, from among the plurality of the synthesized images C-1, C-2, C-3, . . . displayed on the display screen 140, the control device 106 outputs the data of the selected synthesized image C-2 to the image output device 101. As a result, the printer or the like serving as the image output device 101 provides a hard copy on which the synthesized image C-2 is printed. Instead, the data of the synthesized image C-2 may be stored in a recording medium such as a FD by, for example, the FD drive serving as the image output device 101.

If the user does not like any one of the synthesized images C-1, C-2, C-3, . . . on the display screen 140, the program returns to step S1 according to the user's instruction at which the control device 106 executes the processing again.

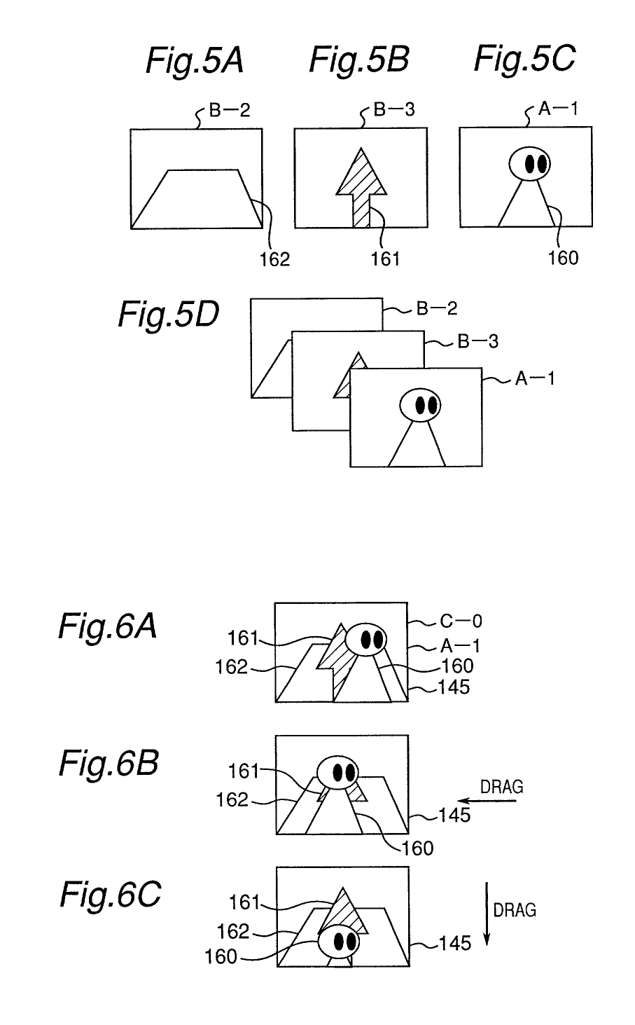

To describe the image synthesis processing (step S2 of FIG. 2), it is assumed that the input image A-1 represents a person 160 which is an object, as shown in FIG. 5C, that the background image B-3 represents a tree 161, as shown in FIG. 5B, and that the background image B-2 represents a mountain 162, as shown in FIG. 5A. These images are to be synthesized in an overlapped or superimposed manner, with the input image A-1 placed forward, the background image B-3 placed intermediately, and the background image B-2 placed rearward, as shown in FIG. 5D.

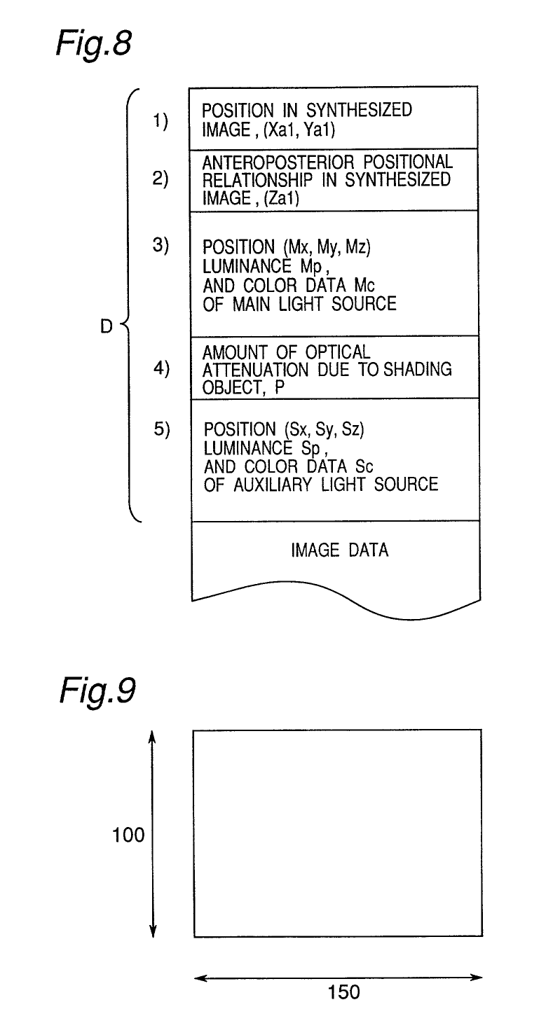

As shown in FIG. 8, the attribute data D indicating the synthesizing conditions include the information of:

1) Position in synthesized image, (Xa1, Ya1);

2) Anteroposterior positional relationship in synthesized image, (Za1);

3) Position (Mx, My, Mz), luminance Mp, and color data Mc of main light source;

4) Amount of optical attenuation due to shading object, P;

5) Position (Sx, Sy, Sz), luminance Sp, and color data Sc of auxiliary light source.

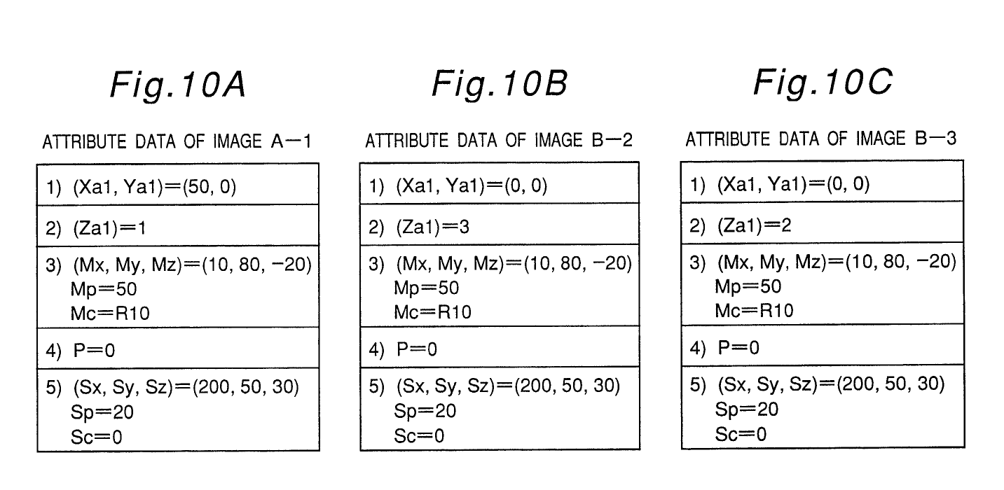

As shown in FIGS. 10A, 10B, and 10C, the attribute data D are set for the data of each of the images A-1, B-2, and B-3 in the image synthesis processing.

The above item 1), “position in synthesized image, (Xa1, Ya1)”, represents (X, Y) coordinates of the lower left corner of each of the images A-1, B-3, and B-2 when placed on an X-Y plane (Z=0) of a (X, Y, Z) three-dimensional rectangular coordinate system, as shown in FIG. 12. In the example shown in FIG. 12, position (Xa1, Ya1) of the input image A-1 is (50, 0), and positions (Xa1, Ya1) of the background images B-3, B-2 are each (0, 0).

The above item 2), “anteroposterior positional relationship in synthesized image, (Za1)”, represents the order in which the images A-1, B-3, and B-2 selected by the user are overlapped in Z-direction. That is, they are overlapped on each other in the order of (Za1)=1, 2, 3, . . . , i.e., a lower-numbered image is positioned forward in FIG. 12.

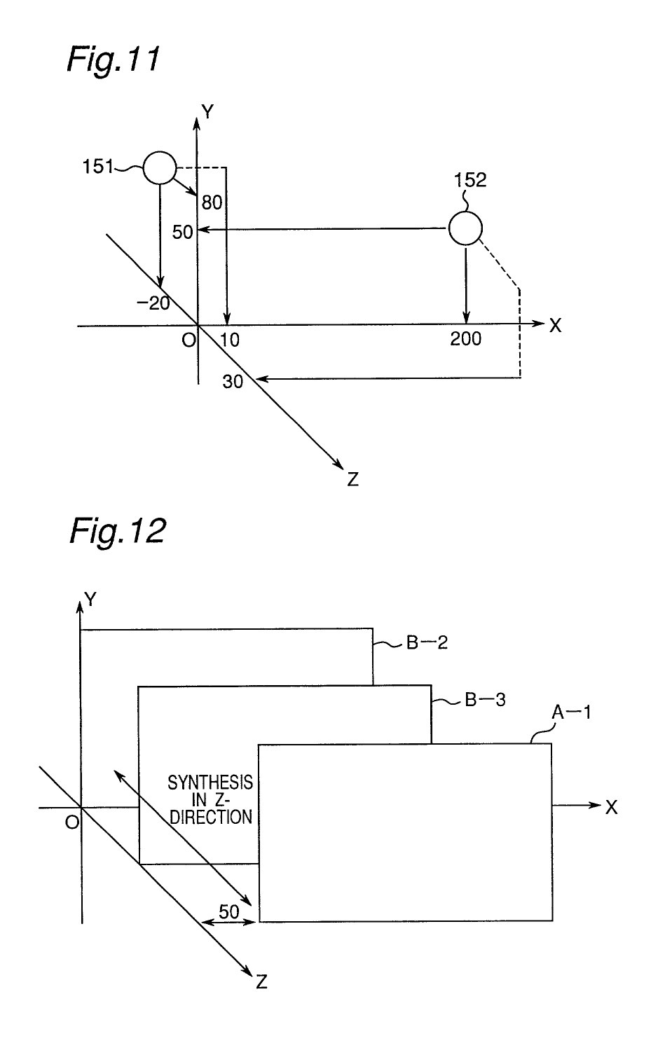

The item 3), “position (Mx, My, Mz) of main light source” represents the (X, Y, Z) coordinates of a main light source 151 in the XYZ space shown in FIG. 11. In the example shown in FIG. 11, (Mx, My, Mz)=(10, 80, −20). The item “luminance Mp of main light source” represents a relative luminance (minimum value: 0, maximum value: 100) of the main light source 151. The item “color data Mc of main light source” represents a degree (%) of increasing/decreasing an amount of each of the components of red (R), green (G), and blue (B) of the main light source 151 with respect to a reference color of white (Mc=0).

The attribute data item 4), “amount of optical attenuation due to shading object, P”, represents a degree by which the luminance of an image should be attenuated when a shading object is present between the light source and an object in the image. When no shading object is present therebetween, the attenuation amount P is set to 0.

The attribute data item 5), “position (Sx, Sy, Sz) of auxiliary light source”, represents the (X, Y, Z) coordinates of the position of an auxiliary light source 152 in the XYZ space shown in FIG. 11. In the example shown in FIG. 11, (Sx, Sy, Sz)=(200, 50, 30). The item “luminance Sp of auxiliary light source” represents a relative luminance (minimum value: 0, maximum value: 100) of the auxiliary light source 152. The “color data Sc of auxiliary light source” represents a degree (%) of increasing/decreasing an amount of each of the components of red (R), green (G), and blue (B) of the auxiliary light source 152 with respect to white (Sc=0) set as the reference.

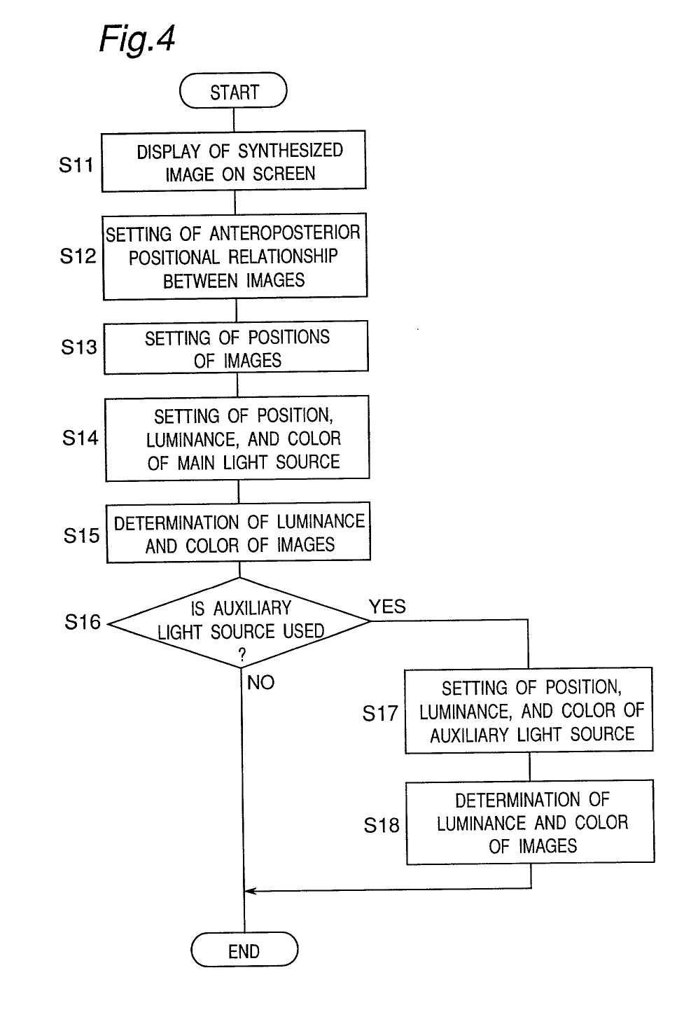

The image synthesis processing (step S2 of FIG. 2) is executed in accordance with the operation flow shown in FIG. 4.

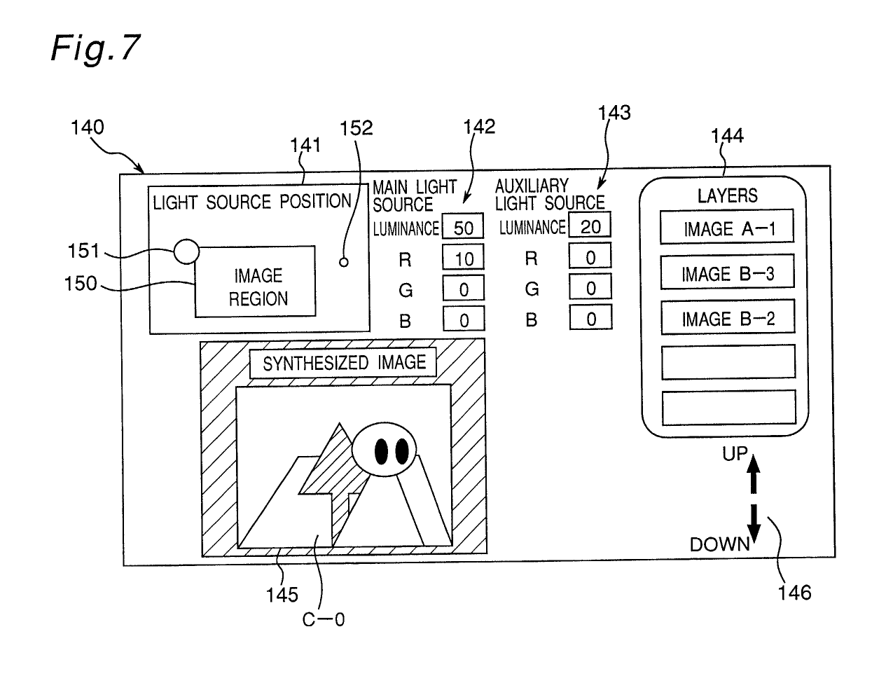

i) Initially, at step S11, attribute data D of the images A-1, B-3, and B-2 selected by the user are initialized. Then, based on the initial values of the attribute data D, the images A-1, B-3, and B-2 are synthesized, and a generated synthesized image C-0 is displayed on the display screen 140, as shown in FIG. 7.

The initial values of the attribute data D are arbitrarily set. For example, the following initial values can be adopted for each of the images A-1, B-3, and B-2:

| | |
|---|---|
| 1) | Position in synthesized image, (Xa1, Ya1) = (0,0) |
| 2) | Anteroposterior positional relationship in |
| | synthesized image, (Za1), is set according to |
| | the order in which the user selects the images |
| | A-1, B-3, and B-2. |
| 3) | Position of main light source, (Mx, My, Mz) = (200, 50, 30) |
| | Luminance of main light source, Mp = 100 |
| | color data of main light source, Mc = 0 |
| 4) | Amount of optical attenuation due to shading object, P = 0 |
| 5) | Position of auxiliary light source, (Sx, Sy, Sz) = (200, 50, 30) |
| | Luminance of auxiliary light source, Sp = 0 |
| | Color data of auxiliary light source, Sc = 0 |

The setting Sp = 0 means that the auxiliary light source 152 is not used.

The display screen 140 has a light source position setting region 141 for setting the position of each of the light sources 151, 152 with respect to an image region 150. The display screen 140 also has a region 142 for setting the luminance and color data (RGB) of the main light source 151, a region 143 for setting the luminance and color data (RGB) of the auxiliary light source 152, a layer setting region 144 for setting the anteroposterior positional relationship in the synthesized image, and a synthesizing screen 145 for displaying the synthesized image.

ii) Then, at step S12, the user sets the anteroposterior positional relationship among the images A-1, B-3, and B-2 in the synthesized image.

More specifically, upon selection of one of the images A-1, B-3, and B-2 in the layer setting region 144 followed by selection of an “UP” key or a “DOWN” key 146 by the user, the value of the “anteroposterior positional relationship in synthesized image, (Za1)” of the selected image A-1, B-3, or B-2 is altered. As a result, the anteroposterior positional relationship (i.e., order in which the images are layered or laid one on another in a depth direction) between the key-operated image and the remaining images is automatically changed. A synthesized image formed after this change is immediately displayed on the synthesizing screen 145.

iii) Then, at step S13, the user sets the XY-direction positions of the images A-1, B-3, and B-2.

For example, suppose that the user selects the image A-1 in the layer setting region 144 and then drags the image A-1 on the synthesizing screen 145 from the position shown in FIG. 6A to the position shown in FIG. 6B or from the position shown in FIG. 6A to the position shown in FIG. 6C. In association with the drag operation, the value of the attribute data “position in synthesized image, (Xa1, Ya1)” of the image A-1 is altered. In consequence of this, the image A-1 moves automatically on the synthesizing screen 145 in the dragged direction (shown with arrow).

iv) Then, at step S14, the user sets the position, luminance, and color of the main light source 151.

More specifically, suppose that the user selects a mark (represented with a large circle ◯ in FIG. 7) of the main light source 151 in the light source setting region 141 and then drags the mark. In association with the drag operation, the value of the attribute data “position (Mx, My, Mz) of main light source” of each of the images A-1, B-3, and B-2 is altered. If the user sets the luminance and color data of the main light source 151 in the region 142 adjacent to the light source setting region 141, the value of the “luminance Mp of main light source” and the value of the “color data Mc of main light source” are altered.

v) If the position, luminance, and color of the main light source 151 are once set, the control device 106 determines the luminance and color of each of the images A-1, B-3, and B-2 on the basis of the position, luminance, and color of the main light source 151 at step S15.

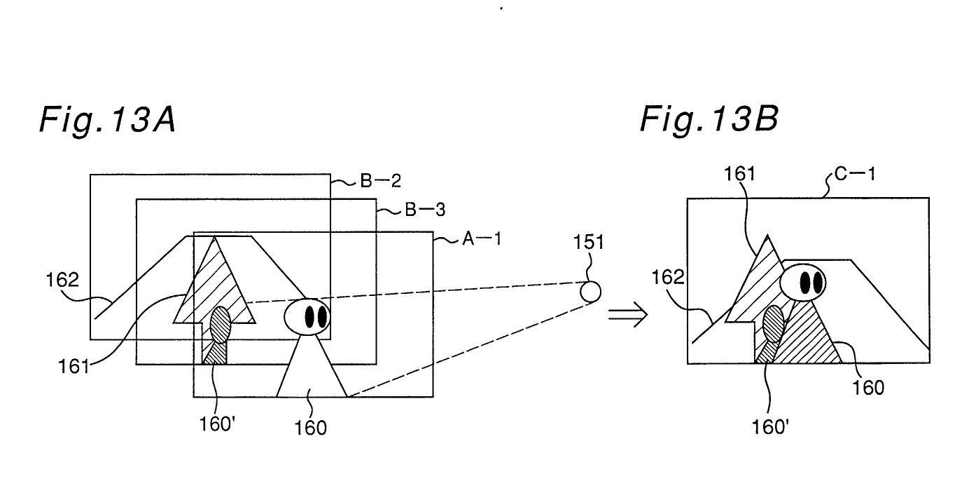

The luminance and color of each of the images A-1, B-3, and B-2 are set by setting the luminance and color data of individual pixels, or picture elements (image bits), constituting the respective images A-1, B-3, and B-2. For example, if the main light source 151 is located in front of the image A-1, as shown in FIG. 13A, a shadow 160′ of the person 160 can be attached to the tree 161 in the image B-3, based on the positional relationship between the person 160 in the image A-1 and the tree 161 in the image B-3. As a result, as shown in FIG. 13B, it is possible to obtain a natural synthesized image C-1 that does not give a viewer a feeling that the synthesized image contains something incongruous.

vi) Then, at step S16, seeing the synthesized image C-1 currently displayed on the display screen 145, the user decides whether the auxiliary light source 152 should be provided.

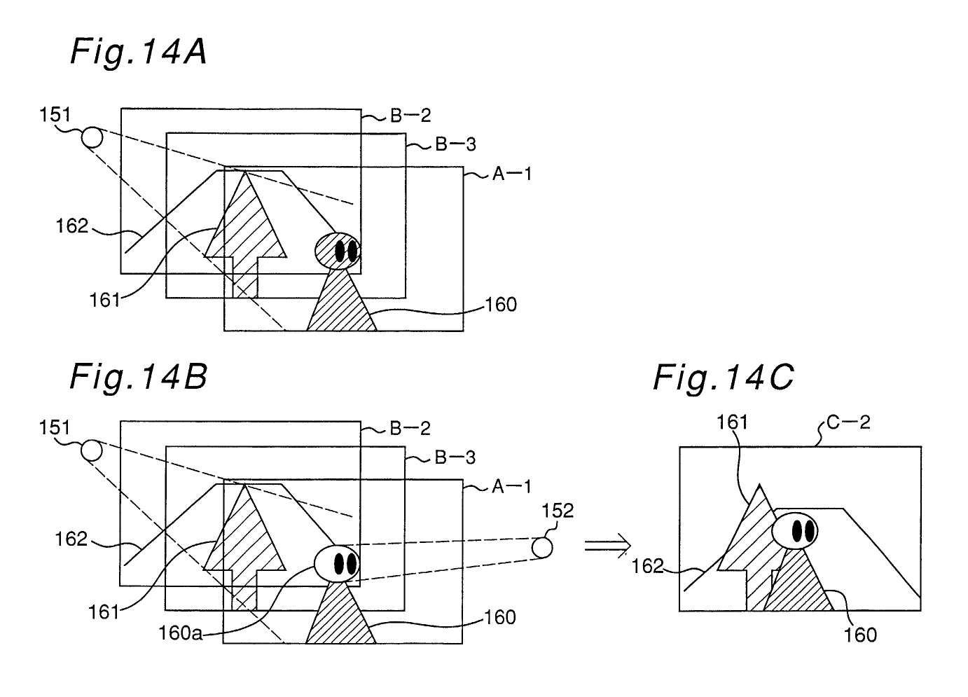

Suppose that as shown in FIG. 14A, the synthesized image C-1 has an atmosphere at sunset and that the attribute data of item 3) of each of the images A-1, B-3, and B-2 has been set as follows:

Position of main light source, (Mx, My, Mz) = (10, 80, −20)
Luminance Mp = 50
Color data Mc = R10 (namely, red: 10% up)

The color data Mc has been set to R10 (red: 10% up) to work the main light source 151 as the reddish setting sun. Under this condition, the objects are subjected to the backlight. Thus, the person 160 of the image A-1 is displayed darkly. In such a case, it is desirable to use the auxiliary light source 152 to display the person 160 of the image A-1 brightly.

vii) Thus, at step S17, the user will select a mark (indicated by a small circle ∘ in FIG. 7) of the auxiliary light source 152 in the light source position setting region 141, and set the position, luminance, and color of the auxiliary light source 152 as in the case of the main light source 151.

For example, the attribute data of item 5) of each of the images A-1, B-3, and B-2 is set as follows:

Position of auxiliary light source, (Sx, Sy, Sz) = (200, 50, 30)
Luminance Sp = 20
Color data Sc = R10

Based on the setting, at step S18, the control device 106 corrects and determines the luminance and color of each of the images A-1, B-3, and B-2. As a result, as shown in FIG. 14B, the face 160a of the person 160 in the image A-1 is displayed brightly. Further, because the color data Sc of the auxiliary light source 152 is set to R10 (red: 10% up) which is the same as that of the main light source 151, the face 160a of the person 160 in the image A-1 is reddish and matches the atmosphere at sunset. Thus, a resulting synthesized image does not give a viewer a feeling that there is something incongruous in the synthesized image. In this manner, a natural synthesized image C-2 as shown in FIG. 14C is obtained.

The synthesized images C-1, C-2, . . . thus generated are stored in the storage device 107 if desired. According to a user's instruction, the stored images are displayed in an arrayed manner on the display screen 140 of the display device 104. As an example, by storing in the storing device 107 the synthesized image (shown in FIG. 14A) formed by not using the auxiliary light source 152 and the synthesized image C-2 (shown in FIG. 14C) formed by using the auxiliary light source 152, the user can compare those two synthesized images, arranged on the display screen 140, with each other. As another example, by generating the synthesized image C-2 shown in FIG. 14C and storing it in the storing device 107 and then generating a synthesized image by replacing the background image B-2 representing the mountain 162 with a background image representing the sea and storing it in the storing device 107, the user can compare both synthesized images with each other on the display screen 140. Accordingly, the user is allowed to readily select a synthesized image according to the user's preference by comparing displayed synthesized images with each other.

In the above example, the attribute data D of each of the images A-1, B-3, and B-2 are set to the initial values when the image synthesis processing starts. But it is possible to use the attribute data set in the preceding image synthesis processing for the current image synthesis processing. In this case, it is easy to create a synthesized image in the same situation as that of the previous image synthesis processing. For example, in generating a synthesized image by replacing the background image B-2 representing the mountain 162 with the background image representing the sea after generating the synthesized image C-2 shown in FIG. 14C, the attribute data set for the background image B-2 can be used. In this case, it is unnecessary to readjust the parameters of the light sources 151 and 152 for the background image representing the sea. Accordingly, the user can readily generate a synthesized image having the background containing the sea and the atmosphere at sunset.

In this embodiment, the input image representing an object photographed by the video camera serving as the image input device 102 is set as the first image data A to be synthesized. But it is also possible to use an image the user has recorded on a recording medium such as an FD or a PC card as the first image data A. Further, the second image data B can include not only background images but also an image of a frame for a synthesized image.

As apparent from the above description, the present invention is applicable to apparatuses synthesizing a plurality of images, such as a seal printer, a picture postcard printer, and the like.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An apparatus which synthesizes a first image and a second image to obtain a synthesized image, comprising:
a storage device which stores attribute data representing image synthesis conditions, said attribute data including data concerning a main light source for the synthesized image; and
a processor which image-processes the first and second images on the basis of said attribute data to thereby synthesize these images.

2. The apparatus according to claim 1, wherein said processor image-processes the first and second images such that illumination conditions for the synthesized image meet the data concerning the main light source.

3. The apparatus according to claim 1, wherein said data concerning the main light source includes a position of the main light source in the synthesized image.

4. The apparatus according to claim 1, wherein said data concerning the main light source includes luminance of the main light source.

5. The apparatus according to claim 1, wherein said data concerning the main light source includes color of the main light source.

6. The apparatus according to claim 1, wherein said attribute data further includes data concerning an auxiliary light source for the synthesized image, and said processor image-processes the first and second images such that illumination conditions for the synthesized image meet both the data concerning the main light source and the data concerning the auxiliary light source.

7. The apparatus according to claim 1, wherein said attribute data further includes data indicative of a depth-direction anteroposterior positional relationship between the first and second images in the synthesized image, and said processor image-processes the first and second images such that illumination conditions for the synthesized image meet both the data concerning the main light source and the data indicative of the depth-direction anteroposterior positional relationship.

8. The apparatus according to claim 1, further comprising means for allowing a user to manually set the attribute data.

9. The apparatus according to claim 1, further comprising a display device for displaying the synthesized image.

10. The apparatus according to claim 9, wherein said processor image-processes the first and second images to generate a plurality of different synthesized images, said display device simultaneously displays the plurality of different synthesized images on a screen, and the apparatus further comprises means for allowing a user to select a desired one of the different synthesized images on the screen.

11. The apparatus according to claim 1, wherein said storage device further stores a first group of one or more different image data and a second group of one or more image data, and said processor synthesizes image data selected from said first group and image data selected from said second group as said first and second images.

12. A method for synthesizing a first image and a second image to obtain a synthesized image, comprising the steps of:
setting data concerning a main light source for the synthesized image; and
image-processing the first and second images on the basis of said data concerning the main light source to thereby synthesize these images.

13. The method according to claim 12, wherein in the step of image-processing, the first and second images are image-processed such that illumination conditions for the synthesized image meet the data concerning the main light source.

14. The method according to claim 12, wherein said data concerning the main light source includes a position of the main light source in the synthesized image.

15. The method according to claim 12, wherein said data concerning the main light source includes luminance of the main light source.

16. The method according to claim 12, wherein said data concerning the main light source includes color of the main light source.

17. The method according to claim 12, wherein the step of setting comprises setting a position, luminance, and color of the main light source in this order.

18. The method according to claim 12, further comprising a step of setting data concerning an auxiliary light source for the synthesized image, wherein in the step of image-processing, the first and second images are image-processed such that illumination conditions for the synthesized image meet both the data concerning the main light source and the data concerning the auxiliary light source.

19. The method according to claim 12, further comprising a step of setting data indicative of a depth-direction anteroposterior positional relationship between the first and second images in the synthesized image, wherein in the step of image-processing, the first and second images are image-processed such that illumination conditions for the synthesized image meet both the data concerning the main light source and the data indicative of the depth-direction anteroposterior positional relationship.
